(19) United States
(12) Patent Application Publication
(10) Pub. No.: US 2014/0286020 A1
(43) Pub. Date: Sep. 25, 2014

(54) LIGHTING DEVICE

(71) Applicant: TOP ENERGY SAVING SYSTEM CORP., New Taipei City (TW)

(72) Inventor: WEN-KUEI TSAI, Taipei City (TW)

(73) Assignee: Top Energy Saving System Corp., New Taipei City (TW)

(21) Appl. No.: 13/850,149

(22) Filed: Mar. 25, 2013

(51) Int. Cl. F21K 99/00

(52) U.S. Cl. CPC F21K 9/1355
USPC 362/363

(57) ABSTRACT

A lighting device includes a top housing, a connecting member and a lamp. The connecting member is detachably coupled to the top housing, and has at least one latch pivoted on and fixed to a top surface of the connecting member to be operatively engaged to the top housing. The lamp cover is directly or indirectly coupled to the connecting member.

### BACKGROUND OF THE INVENTION

1. Field of the Invention

The disclosure generally relates to a lighting device, and more particularly to a light-emitting diode lamp.

2. Description of Related Art

Due to various advantages of a light-emitting diode (LED) such as small volume, short response time, low power consumption, high reliability and high feasibility of mass production, the LED has been used as a light source to replace conventional lighting devices such as light bulbs or fluorescent lamps.

The LED has, in theory, a lifetime of tens of thousand hours. Some electronic components, such as an electrolytic capacitor, used in a driving circuit adapted for LED lamps, for example, to reduce output ripple, however, has a lifetime less than ten thousand hours. Therefore, the reliability and the lifetime of the LED lamps are substantially reduced.

Conventional LED lamps are tightly assembled to disallow replacement of a worn-out or outdated LED module and/or lamp cover by users, even a power circuit of the LED lamps is still in good condition, therefore confining usage diversity and harming environment.

For the reason that conventional LED lamps could not be effectively utilized, a need has arisen to propose a novel lighting device to overcome disadvantages of the conventional LED lamps.

### SUMMARY OF THE INVENTION

In view of the foregoing, it is an object of the embodiment of the present invention to provide a lighting device that some constituent parts may be disassembled by users for the purpose of repair, replacement and upgrading.

According to one embodiment, a lighting device includes a top housing, a connecting member and a lamp. The connecting member is detachably coupled to the top housing, and has at least one latch pivoted on and fixed to a top surface of the connecting member to be operatively engaged to the top housing. The lamp cover is directly or indirectly coupled to the connecting member.

### BRIEF DESCRIPTION OF THE DRAWINGS

FIG. 1A shows an exploded elevational view of a lighting device according to one embodiment of the present invention;

FIG. 1B shows a perspective view of an assembled lighting device of FIG. 1A;

FIG. 2A and FIG. 2B show partial schematics of the latch and the top housing of FIG. 1A;

FIG. 2C shows a perspective view of the top housing along with the lamp cover, the bottom housing and the connecting member that are assembled together;

FIG. 3A shows a top view of a bottom surface of the top housing of FIG. 1A; and

FIG. 3B shows a perspective view of the top housing along with the lamp cover, the bottom housing and the connecting member that are assembled together.

### DETAILED DESCRIPTION OF THE INVENTION

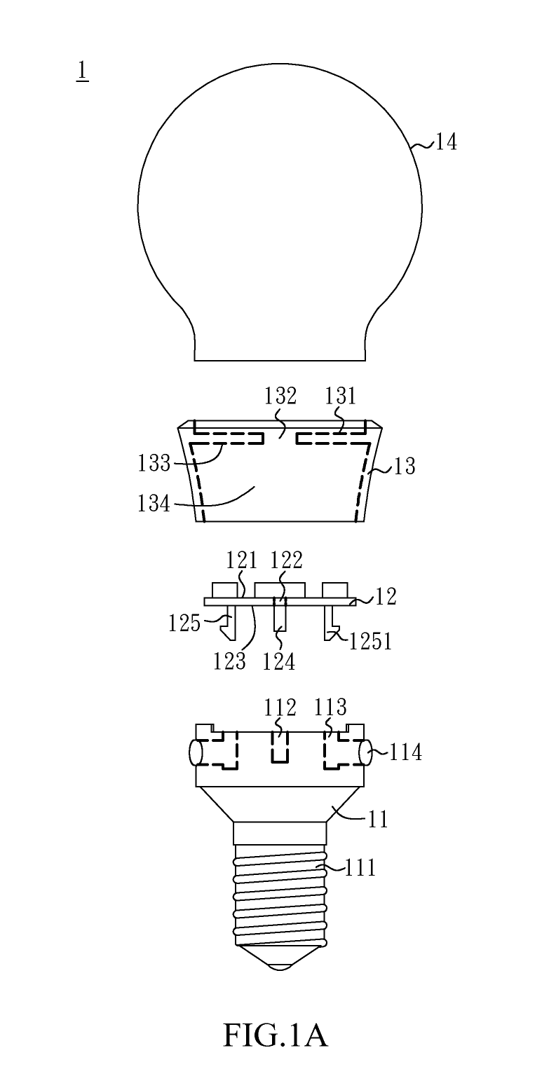

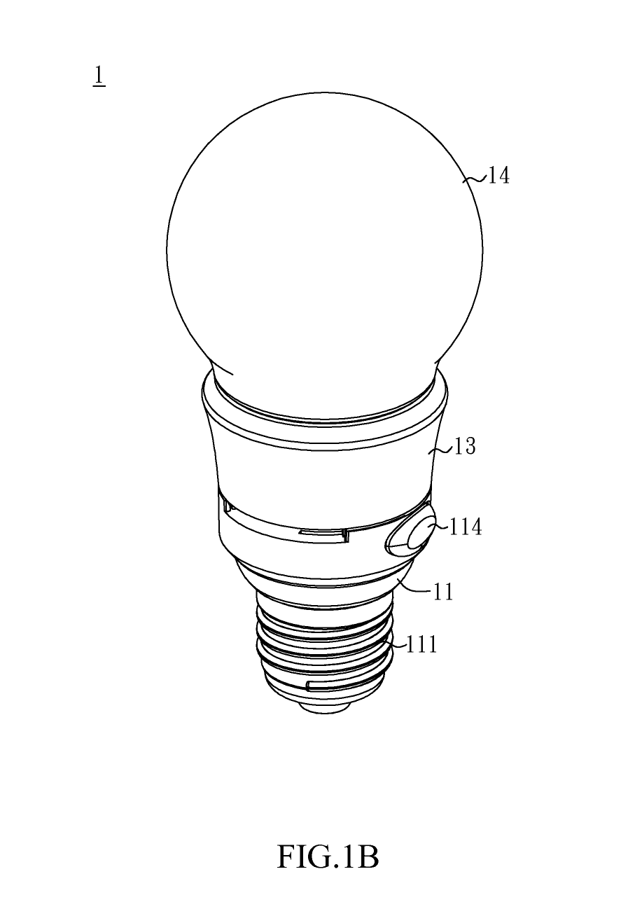

FIG. 1A shows an exploded elevational view of a lighting device 1 according to one embodiment of the present invention, and FIG. 1B shows a perspective view of an assembled lighting device 1 of FIG. 1A. In the embodiment, the lighting device 1 may be a light-emitting diode (LED) lamp. Other lighting elements such as an organic light-emitting diode (OLED), however, may be used as well.

The lighting device 1 of the embodiment includes a top housing 11, a connecting member 12, a bottom housing 13 and a lamp cover 14. In the specification, orientation of the lighting device 1 is defined according to its common use, in which the top housing 11 faces upward and, for example, screws to a lamp socket (not shown), and the lamp cover 14 faces downward.

Specifically speaking, the lamp cover 14 may be used for diffusing light, protection and/or dust proof. The top housing 11 may include a lamp head 111, which may cover a portion of a sidewall of the top housing 11 and may be used as an electrode of the lighting device 1.

The lamp cover 14 may be, temporarily or permanently, coupled to a bottom side of the bottom housing 13. A lighting module (not shown), for example, an LED module, may be supported by and fastened to a bottom surface 131 of the bottom housing 13. The bottom housing 13 may have at least one line hole 132 that passes between the bottom surface 131 and a top surface 133 of the bottom housing 13 to accommodate an electrical wire or wires (not shown). For example, the bottom housing 13 may have two line holes 132 operatively adapted to accommodate a positive power wire and a negative power wire, respectively. A space 134 may be configured above the top surface of the bottom housing 13, for example, to accommodate electronic devices or components. The bottom housing 13 may be made up of a material, e.g., metal, that capably assists in dissipating LED-generated heat out of the lighting device 1. The bottom housing 13 may be equipped with a heat dissipating device, e.g., heat sink, to dissipate LED-generated heat out of the lighting device 1.

In the embodiment, the connecting member 12 may be coupled between the bottom housing 13 and the top housing 11. Specifically speaking, a bottom side of the connecting member 12 may be, temporarily or permanently, coupled to a top side of the bottom housing 13. A top side of the connecting member 12 may be detachably coupled to a bottom side of the top housing 11. Generally speaking, the connecting member 12 may be mechanically affixed to the bottom housing 13 via a fastener. Electronic devices or components (not shown), for example, an electrolytic capacitor, may be supported by and fastened to a bottom surface 121 of the connecting member 12. The connecting member 12 may have at least one line hole 122 that passes between the bottom surface 121 and a top surface 123 of the connecting member 12 to accommodate an electrical wire or wires (not shown). For example, the connecting member 12 may have two line holes 122 operatively adapted to accommodate a positive power wire and a negative power wire, respectively. The connecting member 12 may further have at least one supplementary line hole (not shown) that passes between the bottom surface 121 and the top surface 123 of the connecting member 12 and is operatively adapted to accommodate further electrical wires other than the positive and negative power wires. In an alternative embodiment, the lamp cover 14 may be directly coupled to the connecting member 12 without the bottom housing 13.

According to one aspect of the embodiment, a conductive post 124 extends from the top surface 123 of the connecting member 12. The conductive post 124 may be operatively inserted to a corresponding line hole 112 of the top housing 11 such that a power circuit (not shown) disposed in the top housing 11 may provide electric power to the lighting module (in the bottom housing 13) via the conductive post 124 and electrical wires (in the line holes 122 and 132).

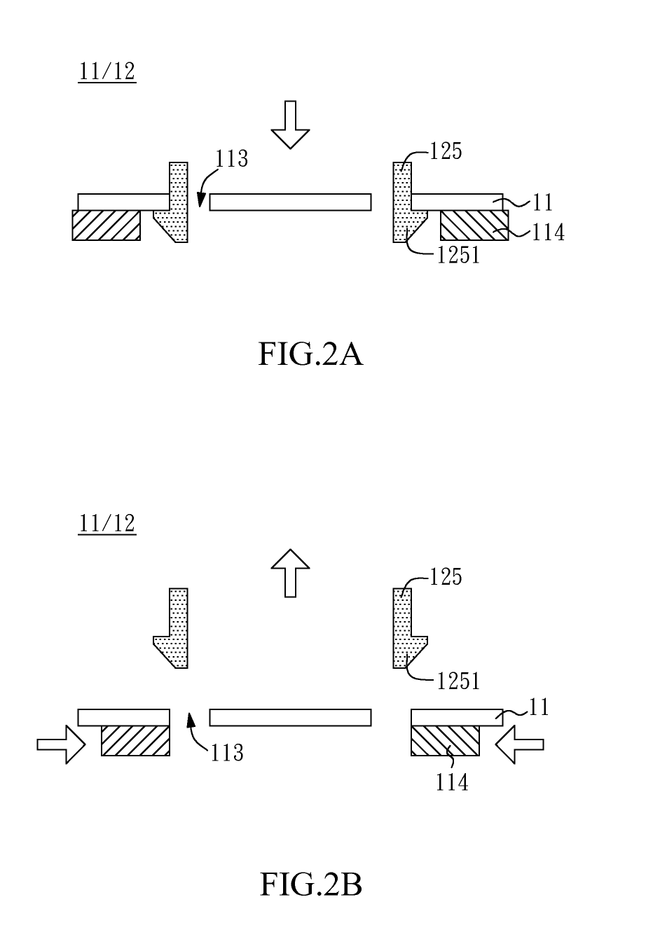

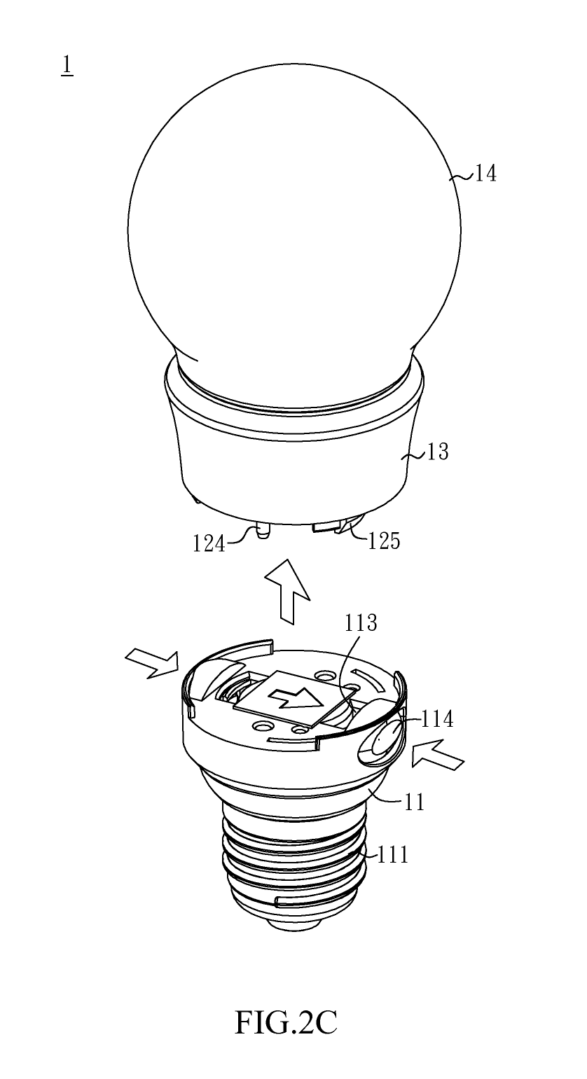

According to another aspect of the embodiment, at least one latch (or hook) 125 is pivoted on and fixed to the top surface 123 of the connecting member 12. FIG. 2A and FIG. 2B show partial schematics of the latch 125 and the top housing 11, and FIG. 2C shows a perspective view of the top housing 11 along with the lamp cover 14, the bottom housing 13 and the connecting member 12 that are assembled together. As shown in FIG. 2A, when the latch 125 inserts into a corresponding catch hole 113 of the top housing 11, a curved portion 1251 of the latch 125 finally engages and firmly fastens to the top housing 11. As shown in FIG. 2A, the top housing 11 is equipped with at least one release bar 114 corresponding to the at least one latch 125 respectively. As shown in FIG. 2B and FIG. 2C, when the release bar 114 is pressed inward to push the curved portion 1251 of the latch 125, the latch 125 (of the connecting member 12) may therefore be separated from the top housing 11.

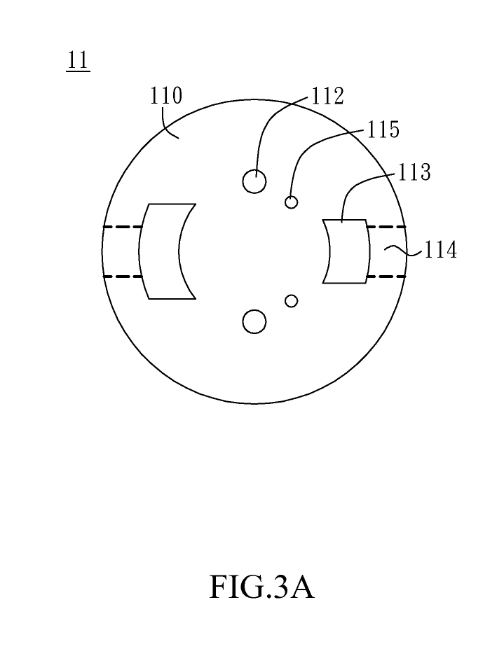

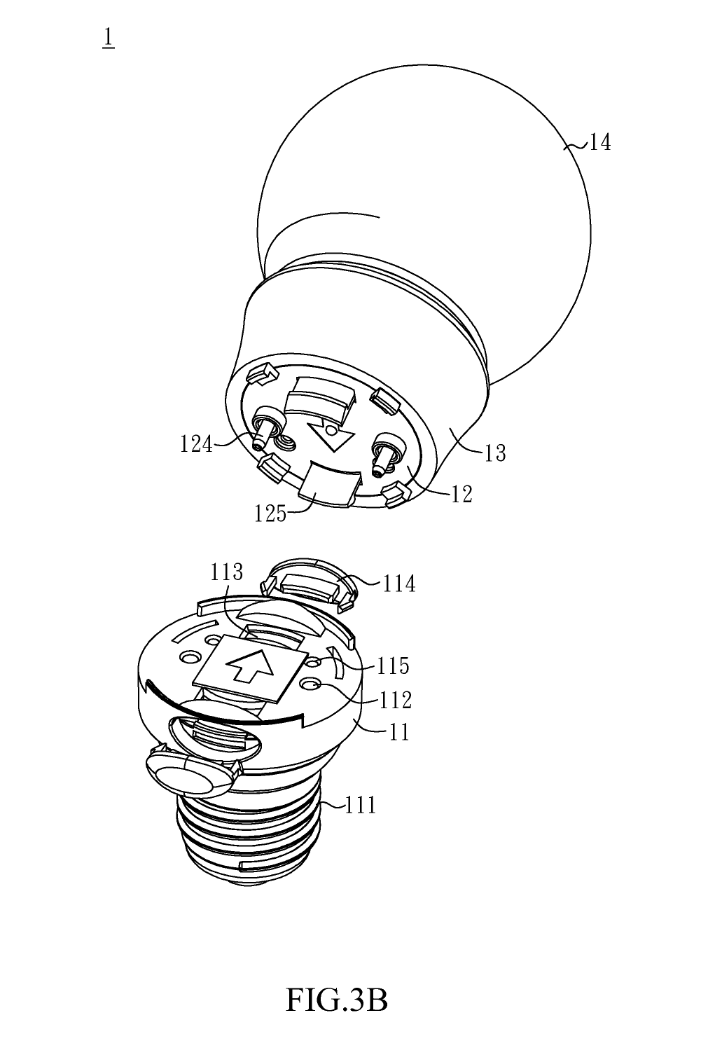

FIG. 3A shows a top view of a bottom surface 110 of the top housing 11, and FIG. 3B shows a perspective view of the top housing 11 along with the lamp cover 14, the bottom housing 13 and the connecting member 12 that are assembled together. The top housing 11 has two catch holes 113 corresponding to two latches 125 (of the connecting member 12), respectively. Two line holes 112 and two supplementary line holes 115 of the top housing 11 are also depicted in FIG. 3A/3B. According to a further aspect of the embodiment, the two latches 125 (corresponding to the two catch holes 113) have different lengths to construct a foolproof mechanism. Accordingly, the connecting member 12 can only be coupled to the top housing 11 in one way.

The lighting device 1 of the embodiments as described above may be adapted to a variety of applications. For example, worn-out electronic devices or components (e.g., an electrolytic capacitor) disposed on the bottom surface 121 of the connecting member 12 may be repaired or replaced by decoupling the bottom housing 13 from the connecting member 12, therefore enhancing lifetime of the lighting device 1. For another example, an LED module or the lamp cover 14 may be substituted for an upgraded LED module or a lamp cover 14 of different type by decoupling the lamp cover 14 and/or the bottom housing 13 off the connecting member 12 for increase in usage diversity. In most applications, the top housing 11 with a power circuit may be reused for the benefit of environment.

Although specific embodiments have been illustrated and described, it will be appreciated by those skilled in the art that various modifications may be made without departing from the scope of the present invention, which is intended to be limited solely by the appended claims.

What is claimed is:

1. A lighting device, comprising:
a top housing;
a connecting member detachably coupled to the top housing, the connecting member having at least one latch pivoted on and fixed to a top surface of the connecting member to be operatively engaged to the top housing; and
a lamp cover directly or indirectly coupled to the connecting member.

2. The lighting device of claim 1, wherein the top housing comprises a lamp head configured as an electrode.

3. The lighting device of claim 1, further comprising a bottom housing coupled between the connecting member and the lamp cover.

4. The lighting device of claim 3, further comprising a lighting module supported by a bottom surface of the bottom housing.

5. The lighting device of claim 4, wherein the lighting module comprises a light-emitting diode (LED) module.

6. The lighting device of claim 3, wherein the bottom housing has at least one line hole that passes between a bottom surface and a top surface of the bottom housing to accommodate at least one electrical wire.

7. The lighting device of claim 1, the connecting member comprises a fastener configured to mechanically affix to the lamp cover directly or indirectly.

8. The lighting device of claim 1, wherein the connecting member has at least one line hole that passes between a bottom surface and the top surface of the connecting member to accommodate at least one electrical wire.

9. The lighting device of claim 8, wherein the connecting member further has at least one supplementary line hole that passes between the bottom surface and the top surface of the connecting member and is operatively adapted to accommodate further electrical wires.

10. The lighting device of claim 1, wherein the connecting member further comprises at least one conductive post extending from the top surface of the connecting member and being operatively inserted to a corresponding line hole of the top housing.

11. The lighting device of claim 10, further comprising a power circuit disposed in the top housing to provide electric power via the conductive post.

12. The lighting device of claim 1, wherein the latch comprises a curved portion configured to be engaged and firmly fastened to the top housing when the latch inserts into a corresponding catch hole of the top housing.

13. The lighting device of claim 12, wherein the top housing comprises at least one release bar corresponding to the at least one latch respectively such that, when the release bar is pressed inward to push the curved portion of the latch, the latch is then separated from the top housing.

14. The lighting device of claim 1, wherein the top housing has at least one catch hole corresponding to the at least one latch respectively.

15. The lighting device of claim 1, wherein the connecting member has two latches and the top housing has two catch holes corresponding to the two latches, and the two latches have different lengths to construct a foolproof mechanism such that the connecting member can only be coupled to the top housing in one way.
